(19) United States
(12) Patent Application Publication
(10) Pub. No.: US 2021/0322949 A1
(43) Pub. Date: Oct. 21, 2021

(54) IMPROVEMENT IN AND RELATING TO AN ABSORBENT COMPOSITION

(71) Applicant: William Blythe Limited, Essex (GB)

(72) Inventors: Kevin Wright, Essex (GB); Will Weston, Essex (GB); David Crossley, Essex (GB)

(73) Assignee: William Blythe Limited, Essex (GB)

(21) Appl. No.: 17/272,559

(22) PCT Filed: Oct. 10, 2019
(86) PCT No.: PCT/GB2019/052884

§ 371 Date: Mar. 1, 2021

(30) Foreign Application Priority Data
Oct. 15, 2018 (GB) 1816758.5

(51) Int. Cl. B01J 20/02; B01J 20/26; C10L 3/10; B01J 20/16; B01J 20/24; B01J 20/30

(52) U.S. Cl. CPC B01J 20/0277; B01J 20/261; C10L 3/103; B01J 20/0244; C10L 2290/541; B01J 20/24; B01J 20/0237; B01J 20/3042; B01J 2220/46; B01J 20/16

(57) ABSTRACT

The invention provides an absorbent composition comprising an oxide or a carbonate, the oxide or carbonate comprising one or more transition and/or Group 12 metal and a hydrocolloidal polymer and/or a thermal decomposition product thereof. A method of removing materials such as sulphur containing compounds (such as hydrogen sulphide) or mercury is also provided, as is a method of making an absorbent composition.

### BACKGROUND OF THE INVENTION

The present disclosure relates to an absorbent composition.

The present invention concerns sulphur compound removal. In particular but not exclusively this invention concerns the removal of material from a gas or liquid. Typically (but not exclusively) the absorbent composition is used to remove sulphur or sulphur-containing compounds or other materials, such as mercury, from natural gas. The invention also concerns a method of removing material, such as sulphur, sulphur-containing compounds or mercury from a fluid and a method of making an absorbent composition.

Hydrogen sulphide and other sulphur-containing compounds are removed from natural gas by what is often known as “sour gas” treatment to provide “sweetened” natural gas. It is known to use copper-containing compositions to remove hydrogen sulphide from fluids (see, for example, U.S. Pat. No. 4,983,367 and WO2009/101429). It is further known to use a composition comprising copper carbonate and clay binder to remove hydrogen sulphide from natural gas. Granules of such a composition provide a satisfactory crush strength (typically 15-25N) and have a satisfactory theoretical sulphur absorbing capacity of 350-375 kgm⁻³. However, replacement of spent absorbent material is time-consuming and expensive, and it is therefore desirable to try to improve sulphur absorbing capacity.

The present invention seeks to mitigate the above-mentioned problems. Alternatively or additionally, the present invention seeks to provide an improved absorbent composition for the removal of unwanted materials, such as sulphur, sulphur-containing compounds or mercury, from fluids, such as natural gas.

### SUMMARY OF THE INVENTION

In accordance with a first aspect of the present invention, there is provided an absorbent composition comprising an oxide or a carbonate, the oxide or carbonate comprising one or more transition and/or Group 12 metal, and a hydrocolloidal polymer and/or a thermal decomposition product of the hydrocolloidal polymer.

The applicant has unexpectedly discovered that the use of a hydrocolloidal polymer and/or a thermal decomposition product thereof as a binder facilitates the use of less binder, and/or provides a composition with a greater capacity to absorb sulphur-containing compounds and/or provides a physically stronger composition when formed into a particulate. In order to make the composition in accordance with the present invention, it is typical to form granules comprising the oxide, or carbonate and hydrocolloidal polymer (and any further optional ingredients) and to heat those granules to more than 100° C. (for example to 110° C.) to remove any liquid carrier used to make the granules. This heating may or may not cause some thermal decomposition of the hydrocolloid to form one or more thermal decomposition product. An example of such a hydrocolloidal polymer is gelatin.

Hydrocolloidal polymers are hydrophilic polymers that typically form viscous dispersions and/or gels when dispersed in water. Hydrocolloidal polymers may, if sufficiently diluted, form a dispersion in water that exhibit the properties of a colloid (the name “hydrocolloid” being derived from “hydrophilic colloid”). The hydrocolloidal polymer may be natural or synthetic. A natural hydrocolloidal polymer is a hydrocolloidal polymer that is derived from a natural source. For example, bovine gelatin is a natural hydrocolloidal polymer, being obtained by the hydrolysis of bovine collagen. Polyacrylic acid polymers are examples of synthetic hydrocolloidal polymers. The hydrocolloidal polymer may, for example, comprise a polysaccharide, a polypeptide, a proteoglycan, a glycoprotein, a polyacrylic acid, a polyacrylic amide, a polyvinyl alcohol, a polyvinyl ether or a polypyrrolidone. Examples of a polysaccharide are agar, alginate, arabinoxylan, carrageenan, cellulose (optionally substituted e.g. carboxymethyl cellulose, methyl cellulose, ethyl carboxymethyl cellulose, hydroxyethyl cellulose, hydroxypropyl cellulose), curdlan, gelatin, gellan, beta-glucan, guar gum, locust bean gum, pectin, starch and xanthan gum. Gelatin is an example of a polypeptide hydrocolloidal polymer. Gum Arabic is an example of a proteoglycan hydrocolloidal polymer. The hydrocolloidal polymer may, for example, not comprise gelatin.

Gelatin is a preferred hydrocolloidal polymer, although the hydrocolloidal polymer may not comprise gelatin.

Gelatin is derived from collagen which is typically obtained from animal body parts (such as skin, tendons, ligaments and bones), typically from pigs or cows, but optionally from other animals such as fish. There is no particular limitation in the present invention as to the nature of the gelatin that may be used.

For the avoidance of doubt, the term “hydrocolloidal polymer” in the present application refers to the polymer itself. Furthermore, and without wishing to be bound by theory, it is expected in the present application that the hydrocolloidal polymer is not acting as a hydrocolloid i.e. the polymer is not forming a hydrocolloidal dispersion, not least because the amount of liquid carrier optionally used to make the composition is usually lower than that at which the polymer forms a hydrocolloidal suspension.

For the avoidance of doubt, a transition metal is an element whose atom has a partially filled d sub-shell, or which can give rise to cations with an incomplete d sub-shell.

For the avoidance of doubt, Group 12 metals are zinc, cadmium, mercury and copernicium.

For the avoidance of doubt, the oxide or carbonate may comprise other elements in addition to the one or more transition and/or Group 12 metal. For example, the oxide or carbonate may comprise aluminium.

The composition may comprise more than one oxide or carbonate, the oxide or carbonate comprising one or more transition and/or Group 12 metals, but typically comprises one oxide or one carbonate, the oxide or carbonate comprising one or more transition and/or Group 12 metal.

The composition may comprise more than one hydrocolloidal polymer and/or thermal decomposition product thereof.

The oxide or carbonate may comprise more than one transition and/or Group 12 metal. For example, the oxide or carbonate may comprise more than one transition metal. The oxide or carbonate may comprise more than one Group 12 metal. The oxide or carbonate may, for example, comprise a transition metal and a Group 12 metal. The oxide or carbonate may comprise more than one transition metal and a Group 12 metal. The oxide or carbonate may comprise a transition metal and more than one Group 12 metal.

The oxide or carbonate may be an oxide of one or more transition metals, such as an oxide of a transition metal.

The oxide or carbonate may be a carbonate of one or more transition metals, such as a carbonate of a transition metal and a Group 12 metal.

At least one and optionally each transition metal and Group 12 metal may be from Period 4 or 5 of the periodic table, and optionally from Period 4 of the Periodic Table.

At least one, optionally more than one and optionally each transition metal and/or Group 12 metal may be selected from the group consisting of nickel, copper and zinc.

The oxide or carbonate is optionally a carbonate, and each transition metal and/or Group 12 metal is from Period 4 of the Periodic Table, and is optionally selected from nickel, copper and zinc.

The oxide or carbonate is optionally an oxide, and each transition metal and/or Group 12 metal is from Period 4 of the Periodic Table, and is optionally selected from nickel, copper and zinc. The oxide may optionally comprise one or more additional species, such as aluminium.

The oxide or carbonate is optionally selected from the group consisting of copper carbonate, zinc carbonate, nickel carbonate, copper zinc carbonate, aluminium copper zinc oxide and copper oxide. The oxide or carbonate may be partially or fully hydrated, or may be anhydrous.

For the avoidance of doubt, the term “carbonate” includes a species comprising a CO₃ group. The term “carbonate” includes what is often termed a standard or non-basic carbonate (for example, CuCO₃, NiCO₃ and ZnCO₃ and a basic carbonate (such as Cu₂CO₃(OH)₂ and Cu₃(CO₃)₂(OH)₂ in the case of copper, [(Zn(CO₃)]₂.[Zn(OH)₂]₃ in the case of zinc, and Ni₄CO₃(OH)₆ in the case of nickel. the term “oxide” includes a species with an oxide group. The term “oxide” includes standard oxides, such as zinc oxide and copper oxide.

The composition optionally comprises at least 0.1 wt % hydrocolloidal polymer and/or thermal decomposition product thereof, optionally at least 0.5 wt % hydrocolloidal polymer and/or thermal decomposition product thereof, optionally at least 1.0 wt % hydrocolloidal polymer and/or thermal decomposition product thereof, optionally at least 1.5 wt % hydrocolloidal polymer and/or thermal decomposition product thereof, optionally at least 1.8 wt % hydrocolloidal polymer and/or thermal decomposition product thereof, optionally at least 2.0 wt % hydrocolloidal polymer and/or thermal decomposition product thereof and optionally at least 3.0 wt % hydrocolloidal polymer and/or thermal decomposition product thereof. The amount of hydrocolloidal polymer and/or thermal decomposition product thereof may be determined by reference to the amount of hydrocolloidal polymer used to make the composition, excluding any liquid. For the avoidance of doubt, if the composition comprises more than one hydrocolloidal polymer, the percentage contents of hydrocolloidal polymer are the total contents of all the hydrocolloidal polymers (hence the reference to “hydrocolloidal polymer” and not “a hydrocolloidal polymer”).

The composition optionally comprises no more than no more than 10 wt % hydrocolloidal polymer and/or thermal decomposition product thereof, optionally no more than no more than 8.0 wt % hydrocolloidal polymer and/or thermal decomposition product thereof, optionally no more than 7.0 wt % hydrocolloidal polymer and/or thermal decomposition product thereof, optionally no more than 6.0 wt % a hydrocolloidal polymer and/or thermal decomposition product thereof, optionally no more than 5.0 wt % hydrocolloidal polymer and/or thermal decomposition product thereof, optionally no more than 4.0 wt % hydrocolloidal polymer and/or thermal decomposition product thereof and optionally no more than 3.0 wt % hydrocolloidal polymer and/or thermal decomposition product thereof. The applicant has discovered that the addition of too much hydrocolloidal polymer (in particular, gelatin (for example, more than 10 wt %)) may cause the composition to be too “gummy” and/or may inhibit the components of the composition to mix.

The composition optionally comprises from 0.1 to 10 wt % hydrocolloidal polymer and/or thermal decomposition product thereof based on the weight of the composition, optionally from 0.5 to 6.0 wt % hydrocolloidal polymer and/or thermal decomposition product thereof based on the weight of the composition, optionally from 0.5 to 4.0 wt % hydrocolloidal polymer and/or thermal decomposition product thereof based on the weight of the composition. The applicant has found that these amounts of hydrocolloidal polymer and/or thermal decomposition product thereof can be beneficial in certain copper carbonate compositions.

The composition optionally comprises at least 80% by weight oxide or carbonate, optionally at least 82 wt % oxide or carbonate, optionally at least 84% by weight oxide or carbonate, optionally at least 86% by weight oxide or carbonate, optionally at least 88% by weight oxide or carbonate, optionally at least 90 wt % oxide or carbonate, optionally at least 92% by weight oxide or carbonate, optionally at least 94% by weight oxide or carbonate and optionally at least 96 wt % oxide or carbonate. The above wt % of oxide or carbonate are based on the weight of the composition.

The composition optionally comprises no more than 98 wt % oxide or carbonate, optionally no more than 97 wt % oxide or carbonate, optionally no more than 96 wt % oxide or carbonate, optionally no more than 94 wt % oxide or carbonate, optionally no more than 92 wt % oxide or carbonate, optionally no more than 90 wt % oxide or carbonate, optionally no more than 88 wt % oxide or carbonate and optionally no more than 86 wt % oxide or carbonate. The above wt % of oxide or carbonate are based on the weight of the composition.

The composition optionally comprises from 80 wt % to 98 wt % oxide or carbonate, optionally from 88 wt % to 98 wt % oxide or carbonate, optionally from 90 wt % to 98 wt % oxide or carbonate, optionally from 92 wt % to 98 wt % oxide or carbonate, optionally form 94 wt % to 98 wt % oxide or carbonate and optionally from 96 wt % to 98 wt % oxide or carbonate. The above wt % of oxide or carbonate are based on the weight of the composition.

The composition optionally comprises one or more additional binders. It has been found that it may be advantageous to use another binder in addition to the hydrocolloidal polymer and/or a thermal decomposition product thereof.

The additional binder optionally comprises clay or a mixture of two clays. Such materials have been found to be suitable binders for oxide or carbonate.

The additional binder optionally comprises a clay or a mixture of two or more clays. While it is expected that typically the additional binder will be a single clay, it is possible to mix two or more clays together to form the additional binder.

The additional binder optionally comprises an aluminosilicate clay.

The additional binder optionally comprises Attapulgite clay. It has been found that the use of Attapulgite clay in combination with a hydrocolloidal polymer and/or a thermal decomposition product thereof may be particularly effective.

The composition optionally comprises at least 0.5 wt % additional binder, optionally at least 1.0 wt % additional binder, optionally at least 1.5 wt % additional binder, optionally at least 1.8 wt % additional binder, optionally at least 2.0 wt % additional binder and optionally at least 3.0 wt % additional binder. The wt % above of additional binder are based on the weight of the composition.

The composition optionally comprises no more than 14 wt % additional binder, optionally no more than 13 wt % additional binder, optionally no more than 12 wt % additional binder, optionally no more than 10 wt % additional binder, optionally no more than 8.0 wt % additional binder, optionally no more than 7.0 wt % additional binder, optionally no more than 6.0 wt % additional binder, optionally no more than 5.0 wt % additional binder, optionally no more than 4.0 wt % additional binder, optionally no more than 3.0 wt % additional binder. The wt % above of additional binder are based on the weight of the composition.

The composition optionally comprises from 0.5 wt % to 12 wt % additional binder, optionally from 1.0 wt % to 10 wt % additional binder, optionally from 1.0 wt % to 8.0 wt % additional binder and optionally from 2.0 wt % to 6.0 wt % additional binder. Such amounts of additional binder have proven to be effective in certain oxide or carbonate—based compositions. The wt % above of additional binder are based on the weight of the composition.

The weight or mass ratio of additional binder to hydrocolloidal polymer and/or thermal decomposition product thereof is optionally at least 0.5:1, optionally at least 0.75:1, optionally at least 1:1, optionally at least 1.25:1, optionally at least 1.5:1 and optionally at least 2:1. It has been discovered that it may be beneficial to have about at least the same amount of additional binder as hydrocolloidal polymer and/or thermal decomposition product thereof.

The weight or mass ratio of additional binder to the hydrocolloidal polymer and/or thermal decomposition product thereof is optionally no more than 10:1, optionally no more than 8:1, optionally no more than 6:1, optionally no more than 4:1, optionally no more than 3:1 and optionally no more than 2:1. It has been discovered that it may be beneficial not to have too much additional binder, compared to the amount of hydrocolloidal polymer and/or thermal decomposition product thereof.

The weight or mass ratio of additional binder to the hydrocolloidal polymer and/or thermal decomposition product thereof is optionally from 0.5:1 to 8:1, optionally from 0.5:1 to 6:1, optionally from 0.5:1 to 4:1, and optionally from 0.75:1 to 2:1. It has been discovered that it may be beneficial for the amount of additional binder to be about at least the same as the amount of hydrocolloidal polymer and/or thermal decomposition product thereof, and optionally more than the amount of hydrocolloidal polymer and/or thermal decomposition product thereof, but not excessively so.

The absorbent composition optionally comprises one or more absorbent material in addition to the oxide or carbonate, for example, one or more additional salts of zinc, aluminium or silicon. It is anticipated that such additional absorbent materials would be added in relatively small amounts, for example no more than 20 wt % compared to the weight of the oxide or carbonate.

Optionally, the weight of the oxide or carbonate, the hydrocolloidal polymer and/or thermal decomposition product thereof, the additional binder (if present) and the one or more additional absorbent materials (if present) is 100% of the weight of the absorbent composition.

The absorbent composition is optionally in the form of particles. The particles are optionally sized not to pass through a 1 mm sieve. The absorbent composition optionally comprises particles of size from 2.8 mm to 4.75 mm, for example, sized by using 2.8 and 4.75 mm sieves.

The absorbent composition optionally has a strength of at least 20N, optionally at least 25N, and optionally at least 30N. Strength is determined by sizing the composition using 3.15 mm and 4.0 mm sieves and performing strength testing on the sized individual granules of said composition using a tablet hardness tester.

The absorbent composition optionally has a tapped density (hereinafter “density”) of 1400-1500 kg m⁻³. The density may be determined by loading a known mass of composition into a measuring cylinder, tapping the cylinder to facilitate settling of the composition and measuring the volume of the known mass of composition.

The absorbent composition optionally has an attrition of no more than 6%. The attrition may be determined by the use of a tablet friability tester. Typically, 100 g of dried granules were loaded in to the drum which was then rotated at 60 rpm for 30 minutes. The resulting granules were sieved using a 1 mm sieve with amount lost calculated, based on the amount passing through the 1 mm sieve.

The absorbent composition optionally has a sulphur capacity of at least 23% w/w, optionally at least 24% w/w and optionally at least 25% w/w.

Said particles are optionally generally rounded in shape, and are optionally generally spherical in shape.

The absorbent material is typically dry i.e. contains little, if any, liquid. In this connection, the absorbent material is typically made by mixing the oxide or carbonate, hydrocolloidal polymer, additional binder(s), if present, and other additional absorbent material(s) with a liquid, which is typically water. The liquid is then removed to form the absorbent material of the first aspect of the present invention.

The absorbent composition may optionally consist essentially of the oxide or carbonate, hydrocolloidal polymer and/or a thermal decomposition product thereof, and one or more additional binder. The absorbent material may optionally consist essentially of oxide or carbonate, hydrocolloidal polymer and/or a thermal decomposition product thereof, one or more additional binder and one or more additional absorbent material.

In accordance with a second aspect of the present invention, there is provided a method of making an absorbent composition, the method comprising mixing a hydrocolloidal polymer and an oxide or a carbonate, the oxide or carbonate comprising one or more transition and/or Group 12 metal.

The method may comprise mixing hydrocolloidal polymer and an oxide or a carbonate, the carbonate or oxide comprising one or more transition and/or Group 12 metal in the presence of a liquid. The liquid is typically an aqueous liquid and may be water.

The method may comprise adding an additional binder. The identity of the additional binder may be as described above in relation to the composition of the first aspect of the present invention.

The method may comprise forming a powder mixture comprising an oxide or a carbonate, the oxide or carbonate comprising one or more transition and/or Group 12 metal, and a hydrocolloidal polymer, and optionally one or more additional binders, if present. The relative amounts of said oxide or said carbonate, hydrocolloidal polymer and additional binder(s) in the powder may be determined by reference to the relative quantities described above in relation to the composition of the first aspect of the present invention. The hydrocolloidal polymer may be substantially as described above in relation to the composition of the first aspect of the present invention.

The method may comprise mixing the powder mixture with a liquid, such as an aqueous liquid, for example water or an aqueous solution. The liquid may make-up from 10 wt % to 25 wt % (and optionally from 15 wt % to 20 wt %) of the total weight of said oxide or said carbonate, liquid, hydrocolloidal polymer and additional binder, if present. The term “total weight” indicates the total weight of all of such components. Said oxide or said carbonate may make-up from 65 wt % to 85 wt % (and optionally from 70 wt % to 80 wt %) of the total weight of said oxide or said carbonate, liquid, hydrocolloidal polymer and additional binder, if present. The hydrocolloidal polymer may make-up from 0.05 wt % to 5.0 wt % (and optionally from 0.05 wt % to 4.0 wt %) of the total weight of said oxide or carbonate, liquid, hydrocolloidal polymer and additional binder, if present. The additional binder (if present) may make-up from 1.0 wt % to 8.0 wt % (and optionally from 1.0 wt % to 6.0 wt %) of the total weight of said oxide or carbonate, liquid, hydrocolloidal polymer and additional binder, if present.

The method may comprise forming a precursor composition for an absorbent material. The precursor composition may be in the form of particles, for example. The precursor composition typically comprises a liquid. The precursor composition may comprise 10 wt % to 25 wt % liquid, 65 wt % to 85 wt % of said oxide or carbonate, said oxide or carbonate comprising one or more transition and/or Group 12 metal, 0.05 wt % to 5.0 wt % hydrocolloidal polymer and 1.0 wt % to 8.0 wt % additional binder, based on the weight of the precursor composition. The precursor composition may optionally comprise no additional components other than said liquid, additional binder, hydrocolloidal polymer and said oxide or carbonate. Optionally, the precursor composition may comprise additional components, such as other absorbent materials, such as one or more zinc additional salts. Optionally, the precursor composition may comprise 15 wt % to 20 wt % liquid, 70 wt % to 80 wt % oxide or carbonate, said oxide or carbonate comprising one or more transition and/or Group 12 metal, 0.05 wt % to 4.0 wt % hydrocolloidal polymer and 1.0 wt % to 6.0 wt % additional binder, based on the weight of the precursor composition. Optionally, the total weight of the liquid, oxide or carbonate, hydrocolloidal polymer, additional binder (if present) and additional absorbent material (if present) is 100% of the weight of the precursor composition.

The method may comprise sequentially adding portions of said powder mixture.

The method optionally comprises forming particles, optionally comprising said liquid, if present.

The method may comprise forming liquid-containing particles and removing said liquid from said particles. The liquid-containing particles may comprise the precursor composition mentioned above. The liquid-comprising particles may be substantially spherical. Removing said liquid from said particles may comprise heating liquid-containing particles to an elevated temperature, for example, a temperature of at least 60° C., optionally at least 80° C. and optionally at least 100° C. and optionally of about 110° C. The particles so formed may be substantially spherical.

The absorbent composition may be the absorbent composition of the first aspect of the present invention, or a composition made in accordance with the second aspect of the present invention.

In accordance with a third aspect of the present invention, there is provided a precursor composition as described above in relation to the method of the second aspect of the present invention.

In accordance with a fourth aspect of the present invention, there is provided use of a composition in accordance with the first aspect of the present invention and/or a composition made in accordance with the second aspect of the present invention as an absorbent.

The use may comprise use of the composition to absorb one or more target species from a fluid. The carrier fluid may be a gas or a liquid. The target species may be one or more of sulphur, mercury and at least one sulphur-containing compounds. The sulphur-containing compound(s) may be selected from one or more of hydrogen sulphide, a mercaptan and carbonyl sulphide.

In accordance with a fifth aspect of the present invention, there is also provided a method of removing a target species from a fluid, the method comprising contacting a composition in accordance with the first aspect of the present invention and/or a composition made in accordance with the method of the second aspect of the present invention with the fluid.

The fluid may be one or both of a liquid and a gas.

The target species may comprise one or more of sulphur, mercury and at least one sulphur-containing compound.

The method may comprising contacting moving fluid with said composition. The method may comprise contacting a stream of said fluid with said composition.

The sulphur-containing compound may comprise hydrogen sulphide, a mercaptan or carbonyl sulphide.

For the avoidance of doubt, the method of the present invention may comprise removing more than one sulphur-containing compound from a fluid.

The fluid may comprise a hydrocarbon, such as methane.

The present invention also provides an absorbent composition comprising an oxide or carbonate comprising one or more transition and/or Group 12 metal, and a hydrocolloidal polymer and/or a thermal decomposition product thereof. For the avoidance of doubt, the oxide or carbonate is as defined above in relation to the absorbent composition of the first aspect of the present invention. The hydrocolloidal polymer may be as described above in relation to the absorbent material of the first aspect of the present invention. The absorbent composition may be as described above in relation to the first aspect of the present invention. For example, the hydrcolloidal polymer may comprise gelatin. The absorbent composition may be made and used as described above in relation to the second to fifth aspects of the present invention.

It will, of course, be appreciated that features described in relation to one aspect of the present invention may be incorporated into other aspects of the present invention. For example, the use of the fourth aspect of the invention may incorporate any of the features described with reference to the method of the fifth aspect of the invention and vice versa.

### DESCRIPTION OF THE DRAWINGS

Embodiments of the present invention will now be described by way of example only.

### DETAILED DESCRIPTION

Examples of absorbent compositions in accordance with the present invention and comparative examples were made in accordance with the following method. In general, the metal carbonate or oxide was admixed with gelatin (if present) and Attapulgite clay in the presence of water using a high-sheer granulator. The metal carbonate or oxide, gelatin and the clay were provided as powders.

Examples of compositions in accordance with the present invention and comparative examples which are not the subject matter of the present invention were made as described below with reference to Table 1.

TABLE 1
mixtures used to make examples of absorbent compositions in accordance
with the present invention

| | | Amount of | Amount | Amount | Water | | | | On-size |
|---|---|---|---|---|---|---|---|---|---|
| Example | Oxide or | oxide or | of clay | of gelatin | volume | Density | Strength | % | yield |
| number | carbonate | carbonate (g) | (g) | (g) | (mL) | (g mL⁻¹) | (N) | Attrition | (%) |
| C. Ex. 1 | Copper | 500 | 70 | 0 | 138 | 1.38 | 17 | 2.5 | — |
| | carbonate | | | | | | | | |
| C. Ex. 2 | ″ | 500 | 60 | 0 | 134 | 1.45 | 13.7 | 3 | — |
| C. Ex. 3 | ″ | 500 | 60 | 0 | 130 | 1.38 | 13.1 | 2.8 | — |
| 1 | ″ | 500 | 50 | 20 | 130 | 1.40 | 24.6 | 3 | — |
| 2 | ″ | 500 | 40 | 10 | 135 | 1.38 | 33.2 | 2.4 | — |
| 3 | ″ | 500 | 30 | 10 | 132 | 1.37 | 22.1 | 6.6 | — |
| 4 | ″ | 500 | 30 | 20 | 138 | 1.30 | 22.1 | 0.7 | 71 |
| 5 | ″ | 500 | 25 | 25 | 120 | 1.35 | 35.5 | 1.8 | 74 |
| 6 | ″ | 500 | 25 | 15 | 125 | 1.41 | 32.6 | 2 | 70 |
| 7 | ″ | 500 | 20 | 10 | 140 | 1.43 | 26.2 | 5.1 | 67 |
| 8 | ″ | 500 | 20 | 10 | 138 | 1.35 | 39.4 | 1.7 | 69 |
| 9 | ″ | 500 | 20 | 10 | 136 | 1.42 | 33.7 | 2.9 | 64 |
| 10 | ″ | 500 | 15 | 10 | 142 | 1.32 | 25.6 | 2.9 | 69 |
| 11 | ″ | 500 | 15 | 5 | 140 | 1.26 | 15.0 | 4.09 | 62 |
| 12 | ″ | 500 | 10 | 10 | 130 | 1.40 | 34.6 | 3.2 | 68 |
| C. Ex. 4 | ″ | 500 | 70 | 0 | — | 1.42 | — | — | — |
| 13 | ″ | 500 | 10 | 10 | — | 1.39 | — | — | — |
| C. Ex. 5 | ″ | 500 | 70 | 0 | — | 1.48 | — | — | — |
| 14 | ″ | 500 | 10 | 10 | — | 1.47 | — | — | — |
| 15 | Aluminium | 500 | 10 | 10 | 245 | 1.31 | 27 | 1.3 | |
| | copper zinc | | | | | | | | |
| | carbonate | | | | | | | | |
| C. Ex. 6 | ″ | 500 | 70 | 0 | 216 | 1.28 | 17 | 3.1 | |
| 16 | Copper zinc | 500 | 10 | 10 | 170 | 1.38 | 23 | 0.2 | |
| | carbonate | | | | | | | | |
| C. Ex. 7 | ″ | 500 | 70 | 0 | 165 | 1.35 | 14 | 1.3 | |
| 17 | Copper oxide | 100 | 2 | 2 | N/K | N/K | 12.8 | 1.4 | |
| C. Ex. 8 | ″ | 100 | 8 | 0 | N/K | N/K | 8.8 | 5.8 | |
| 18 | Zinc | 408.5 | 8.17 | 8.17 | 150 | N/K | 12.8 | 4.3 | |
| | carbonate | | | | | | | | |
| C. Ex. 9 | ″ | 408.7 | 57.2 | 0 | 183.5 | N/K | 10.5 | 3.6 | |
| 19 | Nickel | 170.1 | 3.2 | 3.2 | 96 | N/K | 12.3 | 4.8 | |
| | carbonate | | | | | | | | |
| C. Ex. 10 | ″ | 328.15 | 26.3 | 0 | 124 | N/K | 7.2 | 3.2 | |
| 20 | Copper | 500 | 10 | 10 | 140 | 1.34 | 26 | 3.6 | |
| | carbonate | | | | | | | | |
| 21 | Nickel | 500 | 10 | 10 | 160 | 1.31 | 29 | 2 | |
| | carbonate | | | | | | | | |

All materials were used as provided without further treatment or purification. Copper carbonate was obtained from/made by William Blythe Ltd., unless indicated otherwise. Attapulgite clay was obtained from Richard Baker Ltd. Bovine gelatin was obtained from VWR. Fish gelatin was obtained from Sigma Aldrich. The zinc carbonate was a basic carbonate obtained from Alfa Aesar. The nickel carbonate was a basic carbonate and made by William Blythe Limited. The copper oxide was made by William Blythe Limited. The copper zinc carbonate and aluminium copper zinc carbonate were basic, and made by William Blythe Limited.

The Examples are in accordance with the invention of the present application. The prefix “C. Ex.” indicates that the experiment is a comparative example which is not the subject matter of the present application. The presence of a dash “-” or “N/K” indicates that no note was made of the particular attribute or the attribute was not measured.

All Examples bar numbers 20 and 21 were made using bovine gelatin. Examples 20 and 21 were made using fish gelatin.

Examples 1 to 12 and C. Ex. 1 to 3 were made using basic copper carbonate as supplied by William Blythe Limited, having a tapped density of 1.21 g cm⁻³ and a water absorption number (WAN) of 43.5 mL/100 g.

C. Ex. 4 and Example 13 were prepared using a low density (1.15 gcm⁻³) copper carbonate obtained from Taixing Smelting Plant Co., Ltd. China

C. Ex. 5 and Example 14 were prepared using a higher density (1.47 gcm⁻³) copper carbonate obtained from Taixing Smelting Plant Co., Ltd. China.

The amount of oxide or carbonate, clay and gelatin, and water volume indicate the amounts used in the manufacturing process described generally above and in more detail below. The final make-up of the dried particulate composition may be determined from the amount of oxide or carbonate, gelatin and clay used because the water is removed on drying.

The method of making the compositions mentioned above will now be described in more detail. An Eirich EL1 mixer was used to mix and granulate the various components. Mixing/granulation was performed at 30° C. The powdered components (the copper carbonate, the clay and the gelatin (if present)) were blended using the granulator at 2 ms⁻¹ for two minutes. A quantity of mixed powder was removed (30%) and split into three approximately equal portions. The water in the amount shown in Table 1 was then added to remaining powder over a period of about a minute, with the mixer tool set to a speed of 15 m/s to remaining powder over a period of about a minute, with the mixer tool set to a speed of 15 ms⁻¹. Mixing was continued for 105 seconds after the water had been added, and then the mixture was mixed at 20 ms⁻¹ for 5 minutes. After further mixing at 10 ms⁻¹ for 1 minute, the mixer was slowed to 5 ms⁻¹. One of the portions of mixed powder was then added over a period of about 2 minutes. The mixture was then left to mix (roll) for 1 minute. After the tool had been slowed to 2 ms⁻¹ a second portion of mixed powder was added over a period of about two minutes. The mixture was then rolled for 5 minutes, with the mixer being slowed to 2 ms⁻¹ again before the third and final portion of mixed powder is added. The mixture is then rolled for 5 minutes.

The resulting wet granules were dried at 110° C. in a fluid bed drier to produce dried granules.

The resulting dried granules were sieved to a size of 2.8 mm-4.75 mm for analysis. For the purpose of strength testing, granules were further sieved to a size of 3.15 mm-4.0 mm.

The tapped density of the sieved granules was determined by loading a known mass of composition into a measuring cylinder, gently tapping the measuring cylinder to facilitate settling of the composition and then determining the volume of the composition, the density being determined from the mass and volume.

The strength was determined by measuring 25 granules on the tablet hardness instrument and then taking a mean of the result.

The percentage attrition was determined by weighing 100 g of dried granules in to the drum of a tablet friability instrument. The drum was rotated at 60 rpm for 30 minutes. The resulting granules were sieved using a 1 mm sieve with the percentage amount passing through the sieve indicating the amount lost.

On-size yield was determined based on the percentage of wet granules that were inside the 2.8-4.75 mm range (on-size).

The samples, as received, were tested using a modified procedure normally used for wet gas condition testing and modified for a dry gas input stream. The recirculating warm water scrubber was removed, test volume changed and inlet temperature reduced. The tests were run until the outlet H₂S values equalled the inlet values without intermediate analyses on the breakthrough curves which indicated that the absorbent material was saturated. The analytical values therefore represent the total H₂S uptake for the sample under low pressure and temperature. Analytical values for % wt. S are reported on the results from the total S combustion analyses and averaged over duplicate samples.

The conditions used for the test procedure were a nominal material volume of 125 ml, a temperature of 46-65° F., a test gas of 2800-3300 ppm H₂S in nitrogen, a flow rate STP of 310-330 ml/min, feed gas water 0% wt., with a back pressure across the columns of 1 psig.

Analyses of the input and output H₂S values were carried out using Draeger tubes. The runs were terminated when the H₂S outlet values were greater than 2800 ppm for 24 hrs. On termination the columns were flushed with nitrogen and air, emptied. Some samples were ground down for total S % analysis.

The sulphur-absorbing capacity of an existing comparative example composition comprising 100 parts copper carbonate and 14 parts clay, with no gelatin, was measured using four samples to be 23.8±0.9% w/w.

Examples 7 and 9 above were mixed to provide sufficient material to measure sulphur-absorbing capacity. The sulphur-absorbing capacity was found to be 25.7% w/w, an increase compared to the comparative example composition.

The sulphur-absorbing capacity of Examples 13, 14 and Comparative Examples 4 and 5 were also measured and are shown in Table 2.

TABLE 2
sulphur-containing compound absorbing capacity measurements

| | Sulphur compound absorbing capacity |
|---|---|
| Sample | (% w/w) |
| Example 13 | 23.3 |
| Comparative Example 4 | 21.3 |
| Example 14 | 22.2 |
| Comparative Example 5 | 17.1 |

The results of Table 2 clearly demonstrate that for a low density copper carbonate the composition of Example 13 outperforms the analogous composition of C. Ex. 4, and that for a higher density copper carbonate the composition of Example 14 outperforms the analogous composition of C. Ex. 5. The applicant has therefore demonstrated that a hydrocolloidal polymer and/or a thermal decomposition product thereof is a successful binder for different copper carbonates.

Whilst the present invention has been described and illustrated with reference to particular embodiments, it will be appreciated by those of ordinary skill in the art that the invention lends itself to many different variations not specifically illustrated herein as well as combinations of the embodiments that have been discussed. By way of example only, certain possible variations will now be described.

The examples above illustrate the use of clay binders. Those skilled in the art will realise that other such binders may be used.

The examples above illustrate the use of Attapulgite clay. Those skilled in the art will realise that other aluminosilicate clays may be used. Those skilled in the art will realise that other clays more generally may be used, such as bentonite.

The examples above illustrate the use of gelatin. Those skilled in the art will realise that other hydrocolloidal polymer materials may be used, such as other polypeptides. Those skilled in the art will realise that polysaccharide hydrocolloidal polymer materials may be used.

The examples above illustrate a composition that uses copper carbonate as the sole absorbent material. Those skilled in the art will realise that other absorbent materials may be incorporated into the composition, such as zinc, aluminium or silicon materials, aluminium copper zinc carbonate and copper zinc carbonate.

Those skilled in the art will realise that the composition may comprise more than one oxide or carbonate of a transition metal and/or Group 12 metal.

The examples above illustrate a composition in the form of granules which are typically spherical and are sieved to a size of about 2-4 mm. Those skilled in the art will realise that the granules need not be of the size stated and need not be spherical. Furthermore, those skilled in the art will realise that, while desirable, it is not necessary for the composition to be in granular form. For example, the composition may be in powder form.

The examples above describe the removal of hydrogen sulphide from nitrogen. Those skilled in the art will realise that the hydrogen sulphide may be removed form carrier fluids other than nitrogen (such as natural gas). Those skilled in the art will also realise that sulphur-containing compounds other than hydrogen sulphide may be removed, such as mercaptans and carbonyl sulphide. It would also be possible to remove sulphur-containing compounds from a liquid (as opposed to a gas) carrier. Furthermore, other material such as mercury that is found in natural gas may be removed.

The examples above describe how the composition may be made by adding several separate charges of powder material to the mixer. Those skilled in the art will realise that the composition may be made in a different manner.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. An absorbent composition comprising an oxide or a carbonate, the oxide or carbonate comprising one or more transition and/or Group 12 metal, and a hydrocolloidal polymer and/or a thermal decomposition product of the hydrocolloidal polymer.

2. The composition according to claim 1 wherein the hydrocolloidal polymer comprises one or more of a polysaccharide, a glycoprotein, a proteoglycan, a polypeptide, a polyacrylic acid, a polyacrylic amide, a polyvinyl alcohol, a polyvinyl ether, a polypyrrolidone or gelatin.

3. (canceled)

4. The composition according to claim 1 comprising at least 0.5 wt %, and optionally no more than 5.0 wt %, of the hydrocolloidal polymer and/or thermal decomposition product thereof, based on the weight of the composition.

5. (canceled)

6. The composition according to claim 1 comprising from 0.5 to 4.0 wt % of the hydrocolloidal polymer and/or thermal decomposition product thereof, based on the weight of the composition.

7. The composition according to claim 1 comprising at least 80% by weight, and optionally no more than 98 wt % by weight, of said oxide or said carbonate, based on the weight of the composition.

8. (canceled)

9. The composition according to claim 1 comprising from 90 wt % to 98 wt % of said oxide or said carbonate, based on the weight of the composition.

10. The composition according to claim 1 comprising one or more additional binders, wherein the additional binder optionally comprises a clay or a mixture of clays.

11. (canceled)

12. The composition according to claim 10 comprising from 1.0 wt % to 8.0 wt % of the additional binder, based on the weight of the composition.

13. The composition according to claim 1 comprising one or more absorbent materials in addition to said oxide or said carbonate.

14. The composition according to claim 1 wherein the absorbent composition is in the form of particles, optionally sized so as not to pass through a 1 mm sieve.

15. The composition according to claim 1 wherein each transition metal and/or Group 12 metal is from Period 4 or 5 of the periodic table, optionally from Period 4 of the Periodic Table.

16. The composition according to claim 1 wherein the oxide or the carbonate is a basic oxide or basic carbonate, and/or is selected from copper carbonate, zinc carbonate, nickel carbonate, copper zinc carbonate, aluminium copper zinc oxide and copper oxide.

17. (canceled)

18. A method of making an absorbent composition, the method comprising mixing a hydrocolloidal polymer and an oxide or a carbonate, said oxide or carbonate comprising one or more transition and/or Group 12 metals.

19. The method according to claim 18 comprising mixing the hydrocolloidal polymer and said oxide or said carbonate in the presence of a liquid.

20. The method according to claim 18 further comprising adding an additional binder.

21. The method according to claim 18 further comprising forming a powder mixture comprising the oxide or the carbonate and the hydrocolloidal polymer.

22. The method according to claim 18 further comprising forming a precursor composition for an absorbent material, the precursor composition being in the form of particles comprising a liquid, and optionally removing the liquid from the precursor composition thereby providing said absorbent composition.

23. (canceled)

24. A precursor composition obtained from claim 22.

25. An absorbent composition prepared from the method of claim 18, optionally to absorb one or more target species from a fluid, the target species being one or more of sulphur, mercury and at least one sulphur-containing compound.

26. (canceled)

27. A method of removing a target species from a fluid, the method comprising contacting the absorbent composition according to claim 1 with the fluid, wherein the target species optionally comprises one or more of sulphur, mercury and at least one sulphur-containing compound.

28. (canceled)
